(19) United States
(12) Patent Application Publication
(10) Pub. No.: US 2012/0155268 A1
(43) Pub. Date: Jun. 21, 2012

(54) PACKET RELAY DEVICE

(76) Inventor: KEIICHI OHSHIO, Tokyo (JP)

(21) Appl. No.: 13/312,409

(22) Filed: Dec. 6, 2011

(30) Foreign Application Priority Data
Dec. 20, 2010 (JP) 2010-282527

(51) Int. Cl. H04L 12/26

(52) U.S. Cl. 370/235

(57) ABSTRACT

A packet discard detector detects, for each of output ports, a discard of a packet output from the output port. A distribution processor calculates a degree of congestion for each of the output ports based on a result of the detection of the packet discard detector to find a first output port having a degree of congestion exceeding a threshold, and selects a second output port to be used as a packet distribution destination for the first output port. The distribution processor further calculates a distribution ratio for distributing the packet between the first and second output ports based on the degree of congestion. The packet transfer unit distributes the packet input through the input port and having a destination corresponding to the first output port between the first output port and the second output port according to the distribution ratio calculated by the distribution processor.

This application is based upon and claims the benefit of priority from Japanese Patent Application No. 2010-282527, tiled Dec. 20, 2010, the disclosure of which is incorporated herein in its entirety by reference.

### TECHNICAL FIELD

This invention relates to a packet relay device for relaying a packet, such as a router or L3 (Layer 3) switch.

### BACKGROUND ART

The amount of data transmitted in networks such as the Internet has been rapidly increasing due to recent significant increase of the number of data communication users. The Internet is a network designed to perform routing control according to IP (Internet Protocol). On the networks, there are many packet relay devices such as routers for relaying a packet.

A packet relay device uses a routing protocol such as RIP (Routing Information ProtoCol) or OSPF (Open Shortest Path First) to calculate for each of destination IP addresses an optimum path defined by a minimum sum of costs, and records each result in a routing table as path information. Upon receiving a packet, the packet relay device searches the routing table for path information based on its destination IP address, and transmits the packet from an output port specified by this path information. The routing table is updated periodically or whenever the path information is changed.

A path used by a packet relay device relying on a conventional routing protocol such as RIP or OSPF is a unique path that is obtained as an optimum path. Therefore, if traffic is concentrated on that path, congestion may occur in the packet relay device and the packet may be discarded. If the packet is discarded, a retransmission process will be performed, resulting in increased delay time.

In order to solve these problems, techniques have been proposed (see, for example, Japanese Laid-Open Patent Publication No. 2003-244196 (Patent Document 1)). According to the technique disclosed in Patent Document 1, it is first determined whether or not congestion has occurred on a link between adjacent routers based on a traffic amount on the link. If congestion has occurred, a congested part including the link is specified. Then, a load distribution path bypassing the congested part is searched for, and the packet is routed by using both of the load distribution path thus found and the original path including the congested part.

### SUMMARY OF THE INVENTION

According to the technique described in Patent Document 1, load can be distributed between the load distribution path and the original path, resulting in reduction of the risk of occurrence of congestion. However, Patent Document 1 does not mention at all about the ratio in which the packets are distributed between the load distribution path and the original path. This makes it difficult to minimize the risk of occurrence of congestion. For example, if the traffic amount on the original path is significantly great and yet the proportion of packets distributed to the load distribution path is small, the congestion will possibly not be removed.

Therefore, an object of this invention is to provide a packet relay device capable of solving the problems associated with the conventional technique and capable of minimizing the risk of occurrence of congestion.

A first packet relay device according to this invention includes: a plurality of input ports each of which inputs a packet; a plurality of output ports each of which outputs a packet; a packet discard detector for detecting, for each of the output ports, a discard of a packet output from the output port; a distribution processor for calculating a degree of congestion for each of the output ports based on a result of detection by the packet discard detector to find a first output port having a degree of congestion exceeding a threshold, selecting a second output port from the plurality of output ports to be used as a packet distribution destination for the first output port, and calculating a distribution ratio for distributing a packet having a destination corresponding to the first output port between the first output port and the second output port based on the degree of congestion of the first output port; and a packet transfer unit for distributing the packet received through the input port and having a destination corresponding to the first output port, between the first output port and the second output port according to the distribution ratio calculated for the first output port.

A packet relay method according to this invention is applicable to a packet relay device having a plurality of input ports each of which inputs a packet and a plurality of output ports each of which outputs a packet, and the method includes: detecting, for each of the output ports, a discard of a packet output from the output port; calculating a degree of congestion for each of the output ports based on a result of the detection; selecting, from among the plurality of output ports, a second output port to be used as a packet distribution destination for a first output port having a calculated degree of congestion exceeding a threshold; calculating a distribution ratio for distributing a packet having a destination corresponding to the first output port between the first output port and the second output port based on the degree of congestion of the first output port; and distributing the packet input through the input port and having a destination corresponding to the first output port between the first output port and the second output port according to the distribution ratio calculated for the first output port.

A computer readable recording medium according to this invention is a recording medium on which a program for causing a computer having a plurality of input ports each of which inputs a packet and a plurality of output ports each of which outputs a packet to function as a packet relay device, the program being designed to cause the computer to realize: a packet discard detector for detecting, for each of the output ports, a discard of a packet output from the output port; a distribution processor for calculating a degree of congestion for each of the output ports based on a result of detection by the packet discard detector to find a first output port having a degree of congestion exceeding a threshold, selecting from the plurality of output ports a second output port to be used as a packet distribution destination for the first output port, and calculating a distribution ratio for distributing a packet having a destination corresponding to the first output port between the first output port and the second output port based on the degree of congestion of the first output port; and a packet transfer unit for distributing the packet received through the input port and having a destination corresponding to the first output port, between the first output port and the second output port according to the distribution ratio calculated for the first output port.

This invention thus provides an advantageous effect that the risk of occurrence of congestion can be significantly reduced.

### BRIEF DESCRIPTION OF THE DRAWINGS

FIG. 1 is a block diagram illustrating a configuration example of a router according to a first embodiment of this invention;

FIG. 2 is a diagram illustrating an example of contents of a routing table 14;

FIG. 3 is a flowchart illustrating an example of processes to be performed by a header information manager 15;

FIG. 4 is a flowchart illustrating an example of processes to be performed by a packet discard detector 17;

FIG. 5 is a flowchart illustrating part of an example of processes to be performed by a distribution processor 18;

FIG. 6 is a flowchart illustrating the remaining part of the example of the processes to be performed by the distribution processor 18;

FIG. 7 is a flowchart illustrating an example of processes to be performed by a packet transfer unit 13;

FIG. 8 is a diagram for explaining operation of the packet discard detector 17;

FIG. 9 is a diagram illustrating how congestion is removed;

FIG. 10 is a diagram illustrating a configuration example of a router according to a second embodiment of this invention; and

FIG. 11 is a flowchart illustrating an example of processes to be performed by a hop count checking unit 19.

### EXEMPLARY EMBODIMENTS

Exemplary embodiments of this invention will be described in detail with reference to the accompanying drawings.

### First Embodiment

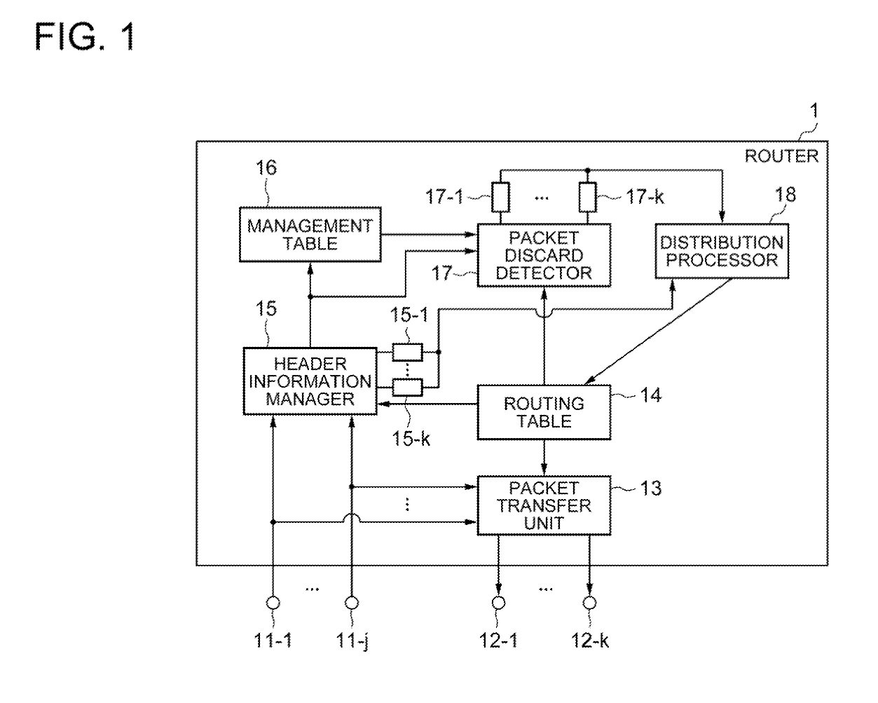

Referring to FIG. 1, a router 1 according to a first embodiment of the invention has a plurality of input ports 11-1 to 11-j, a plurality of output ports 12-1 to 12-k, a packet transfer unit 13, a routing table 14, a header information manager 15, a management table 16, a packet discard detector 17, and a distribution processor 18.

A packet is input into each of the input ports 11-1 to 11-j from an adjacent router (not shown). A packet is output from each of the output ports 12-1 to 12-k to an adjacent router.

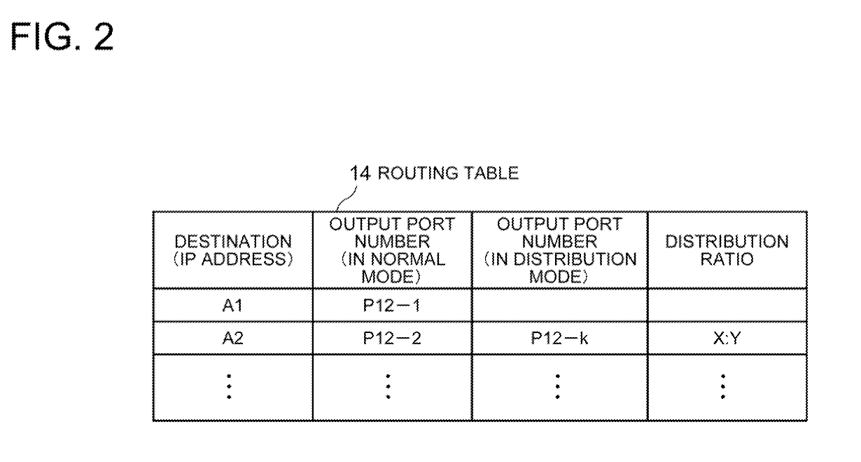

As shown in FIG. 2, there are recorded, in the routing table 14, port numbers of output ports (in normal mode) to which packets are to be originally output, in association with respective destinations of the packets (IP addresses). The routing table 14 of this embodiment is designed to be able to record a port number of an output port (in distribution mode) to which a packet is output when the packet is distributed to this output port in addition to the original output port. Distribution ratios can also be recorded in the routing table 14. The distribution ratio indicates in which ratio packets are distributed between the original output port that is used in normal mode and the output port that is used in distribution mode. The example shown in FIG. 2 indicates that the packet addressed to A1 is output from the output port of the output port number P 12-1, and the packet addressed to A2 is distributed between the output ports of the output port numbers P12-2 and P12-k in a ratio of X:Y.

The packet transfer unit 13 determines an output port to which a packet input to one of the input ports 11-1 to 11-j is to be output, based on the destination of the packet and the contents of the routing table 14, and outputs the packet to the output port thus determined.

The header information manager 15 is provided with transmitted packet counters 15-1 to 15-k corresponding to the output ports 12-1 to 12-k, respectively. Upon receiving a packet through one of the input ports 11-1 to 11-j, the header information manager 15 refers to the routing table 14 to find an output port to which the packet is to be output and increments (by one in this embodiment) the count value of the transmitted packet counter corresponding to the output port. Further, if the protocol field in the IP header of the received packet is TCP (Transmission Control Protocol), the header information manager 15 records the header information of that packet in the management table 16, and passes the packet to the packet discard detector 17. If the received packet is the first one of the connection, only the header information is recorded in the management table 16, and the packet is not passed to the packet discard detector 17. If the received packet is a packet which instructs to disconnect the connection, header information related to the connection (header information in which the destination IP address, the destination port number, the source I.P address, and the source port number are the same as those of the packet, and header information in which the destination IP address, the destination port number, the source IP address and the source port number are replaced with the source IP address, the source port number, the destination IP address and the destination port number of the packet) is deleted from the management table 16.

The packet discard detector 17 is provided with discard detection counters 17-1 to 17-k respectively corresponding to the output ports 12-1 to 12-k. Upon receiving a packet passed from the header information manager 15, the packet discard detector 17 determines whether or not a packet output from the local router 1 has been discarded on the network, based on the received packet and the header information recorded in the management table 16. When it is determined that the packet has been discarded, the packet discard detector 17 finds an output port which has output the discarded packet, based on the packet passed from the header information manager 15 and the contents of the routing table 14, and increments the count value of the discard detection counter corresponding to that output port.

The distribution processor 18 has functions (A) to (F) described below.

(A) Function to calculate a degree of congestion of each of the output ports 12-1 to 12-k. In this embodiment, for example, the degree of congestion of an output port 12-a (1≦a≦k) is defined by a packet discard detection rate which indicates a proportion of the number of packets output from the output port 12-a and discarded during a predetermined period of time to the total number of packets output from the output port 12-a during the predetermined period of time. When the total number of packets output by the output port 12-a is denoted by Ta, and the number of discarded packets is denoted by Na, the packet discard detection rate Pa is represented by the following equation (1).

Pa=Na/Ta (1)

The degree of congestion is not limited to this, but other factors such as the number of packets discarded during a predetermined period of time may be used to calculate the degree of congestion. The total number of packets output from the output port 12-a and the number of packets discarded during the period of time can be respectively obtained by referring to the transmitted packet counter 15-a and the discard detection counter 17-a.

(B) Function to determine whether or not the packet discard detection rate has exceeded a predetermined first threshold Th1 for each of the output ports 12-1 to 12-k.

(C) Function to select, from the other output ports than the output port 12-a, an output port 12-b (1≦b≦k) to which a packet is to be distributed when the packet discard detection rate of the output port 12-a exceeds the threshold Th1. In this first embodiment, the output port having the smallest packet discard detection rate is selected as the output port to which the packet is distributed.

(D) Function to calculate a distribution ratio when packets having a destination corresponding to the output port 12-a are distributed between the output port 12-a and the output port 12-b. In this embodiment, weights A and B of the output ports 12-a and 12-b are calculated according to the following equations (2) and (3), so that the ratio of A:B defines the distribution ratio.

A=1−Pa (2)

B=Pa (3)

In these equations, as described above, Pa denotes a packet discard detection rate of the output port 12-a.

(E) Function to record the port number of the output port 12-b as the packet distribution destination and the packet distribution ratio A:B in the routing table 14 in association with the destination corresponding to the output port 12-a.

(F) Function to determine, for each of the output ports 12-1 to 12-k, whether or not the packet discard detection rate is less than a predetermined second threshold Th2, to determine for any output port having a packet discard detection rate less than the threshold Th2, whether or not the port number of the output port to which the packet is distributed is set in the routing table 14, and, if set, to delete the port number of the output port to which the packet is distributed and the packet distribution ratio froM the routing table 16. The first and second thresholds Th1 and Th2 have a relationship of Th1>Th2.

The packet transfer unit 13, the header information manager 15, the packet discard detector 17, and the distribution processor 18 can be realized by a CPU (central processing unit). When this is the case, a disk, semiconductor memory, or other recording medium is prepared, on which a computer-readable program is recorded to cause the CPU to function as the packet transfer unit 13, the header information manager 15, the packet discard detector 17, and the distribution processor 18, and the. CPU is caused to read the program. The CPU controls its own operation according to the program to realize the packet transfer unit 13, the header information manager 15, the packet discard detector 17, and the distribution processor 18 on the CPU itself.

Next, operation of this embodiment will be described in detail.

The packet input through one of the input ports 11-1 to 11-j is passed to the packet transfer unit 13 and the header information manager 15.

The packet transfer unit 13 determines an output port to which the packet is to be output based on the destination of the packet passed thereto and the contents of the routing table 14, and outputs the packet from the determined output port. This packet is transferred to an adjacent router via a path connecting between the router 1 and the adjacent router.

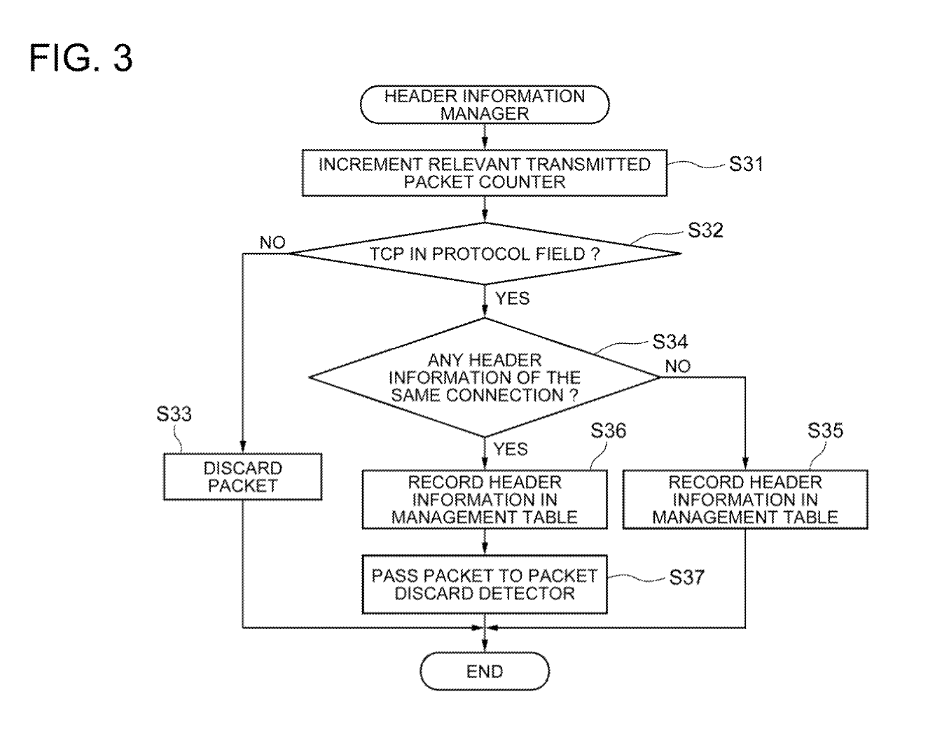

Upon receiving the packet passed thereto, the header information manager 15 increments the count value of the counter corresponding to the output port to which the packet is output, among the transmitted packet counters 15-1 to 15-k provided for the respective output ports 12-1 to 12-k (step S31 in FIG. 3). The output port to which the packet is output can be searched for in the routing table 14.

The header information manager 15 then determines whether or not the content in the protocol field in the IP header of the packet is TCP (step S32). If the content of the protocol field is not TCP but is other protocol such as UDP (User Datagram Protocol) (NO in step S32), the packet is discarded (step S33).

In contrast, if the content of the protocol field is TCP (YES in step S32), the header information manager 15 determines whether or not header information of a packet belonging to the same connection as the packet currently under processing is recorded in the management table 16 (step S34). This determination is performed by determining whether or not there is recorded in the management table 16 header information in which the destination IP address, the destination port number, the source IP address, and the source port number are the same as those of the packet currently under processing, or header information in which the destination port number, the source IP address, and the source port number have been replaced with the with the source IP address, the source port number, the destination IP address, and the destination port number of the packet.

Only header information of a packet having a protocol field of TCP is recorded in the management table 16, because, as described later, a discard of a packet is detected based on a packet retransmitted according to TCP and an acknowledge packet (ACK packet), according to this first embodiment.

If header information of a packet belonging to the same connection as the packet currently under processing is not recorded in the management table 16 (NO in step S34), the header information of this packet is recorded in the management table 16, and an ACK arrival flag is recorded in association with the header information (step S35). The ACK arrival flag indicates whether or not an ACK packet for the packet containing the header information has arrived. In an initial state, the ACK arrival flag “0”. This means that the ACK arrival flag indicates that no ACK packet has arrived in the initial state.

In contrast, if header information of a packet belonging to the same connection is recorded in the management table 16 (YES in step S34), the header information of the packet and the ACK arrival flag are recorded in the management table 16, and this packet is passed to the packet discard detector 17 (steps S36 and S37).

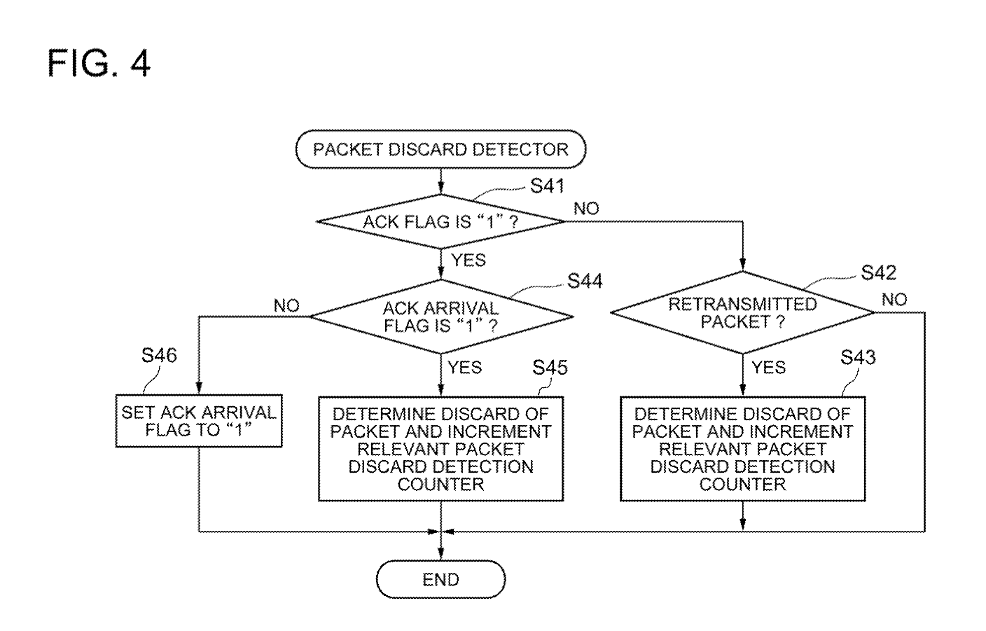

Upon receiving the packet passed from the header information manager 15, the packet discard detector 17 determines whether or not the ACK flag is set in its header, or, in other words, whether or not the ACK flag “1” (step S41 of FIG. 4).

When the ACK flag is “0” (NO in step S41), the packet discard detector 17 determines whether or not the packet currently under processing is a packet retransmitted from the transmission side (step S42). This determination is made based on whether or not header information of a packet belonging to the same connection as the packet currently under processing and having the same acknowledge response number and sequence number as those of the packet is recorded in the management table 16.

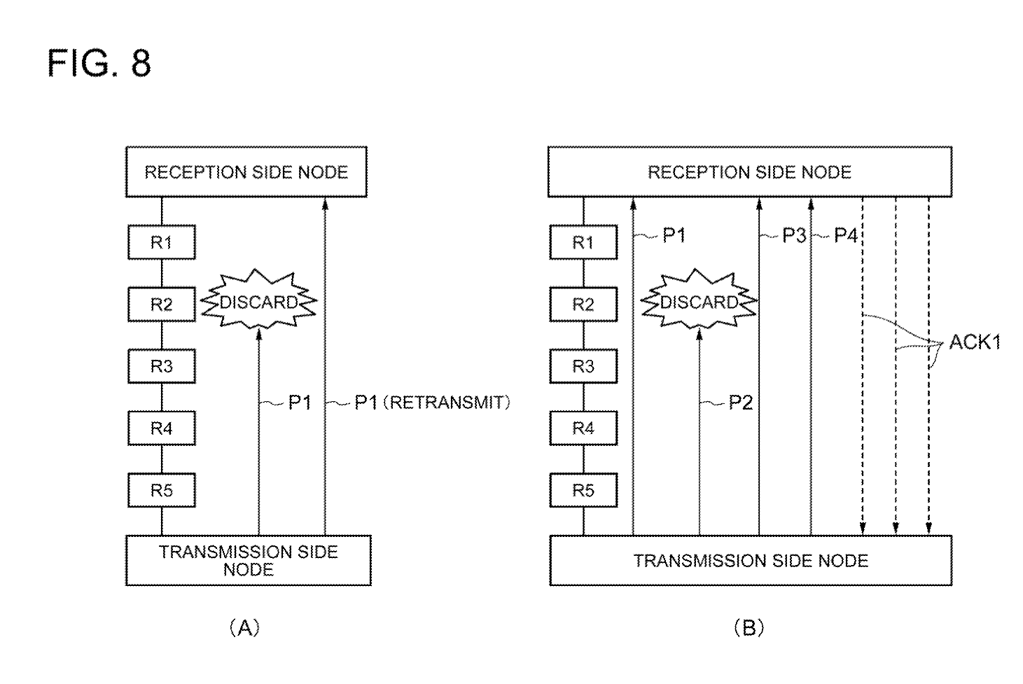

When the packet currently under processing is not a retransmitted packet (NO in step S42), the packet discard detector 17 terminates the processing of the packet. On the contrary, when the packet currently under processing is a retransmitted packet (YES in step S42), the packet discard detector 17 determines that the packet has been discarded, and increments the count value of the discard detection counter corresponding to the output port to which the packet is to be output, among the discard detection counters 17-1 to 17-k provided for the respective output ports 12-1 to 12-k (step S43). If it is assumed, for example, that a packet P1 is transmitted from a transmission side node to a reception side node but the packet P1 is discarded at a router R2, as shown in FIG. 8A, the transmission side node will retransmit the packet P1 since no ACK packet is returned. In this case, the packet discard detector 17 in each of routers R3 to R5 determines YES in step S42, and determines that the packet P1 has been discarded.

When the ACK flag is set in the packet passed from the header information manager 15, or, that is, when the packet passed from the header information manager 15 is an ACK packet (YES in step S41), the packet discard detector 17 determines whether or not the ACK arrival flag, of the ACK arrival flags recorded in the management table 16, that is associated with the header information of the packet the normal reception of which is to be notified by the ACK packet is “1” (step S44). The header information with which the ACK arrival flag is associated is a piece of the header information of the packet belonging to the same connection as the ACK packet, the piece of the header information having an acknowledge response number that matches the sequence number in the ACK packet.

When the ACK arrival flag is “0” (NO in step S44), it means that the packet has been received at the reception side node and the ACK packet has been returned. Therefore, the ACK arrival flag is changed to “1” (step S46).

In contrast, when the ACK arrival flag is “1” (YES in step S44), the packet discard detector 17 determines that the packet has been discarded, and increments the count value of the discard detection counter corresponding to the output port which has output the packet the normal reception of which is to be notified by the ACK packet, among the discard detection counters 17-1 to 17-k provided for the respective output ports 12-1 to 12-k, that (step S45). It is assumed, for example, that packets P1 to P4 are successively transmitted from the transmission side node to the reception side node and the packet P2 is discarded at the router R2, as shown FIG. 8B. The reception side node to which TCP is applied returns an ACK packet ACK1 for the packet P1 to the transmission side node upon receiving the packet P1. The reception side node then receives the packet P3 since the packet P2 has been discarded at the router R2. The reception side node to which TCP is applied transmits, to the transmission side node, the ACK packet for the last packet successfully received during reception of the packets. In this example, the last packet successfully received is the packet P1. Therefore, upon receiving the packets P3 and P4 as well, the reception side node returns to the transmission side node the ACK packet ACK1 which is transmitted upon receiving the packet P1. In this case, the packet discard detector 17 in each of the routers R3 to R5 determines YES in step S44, and determines that the packet has been discarded.

The successful reception of a packet means that the packet and all the preceding packets have been received entirely.

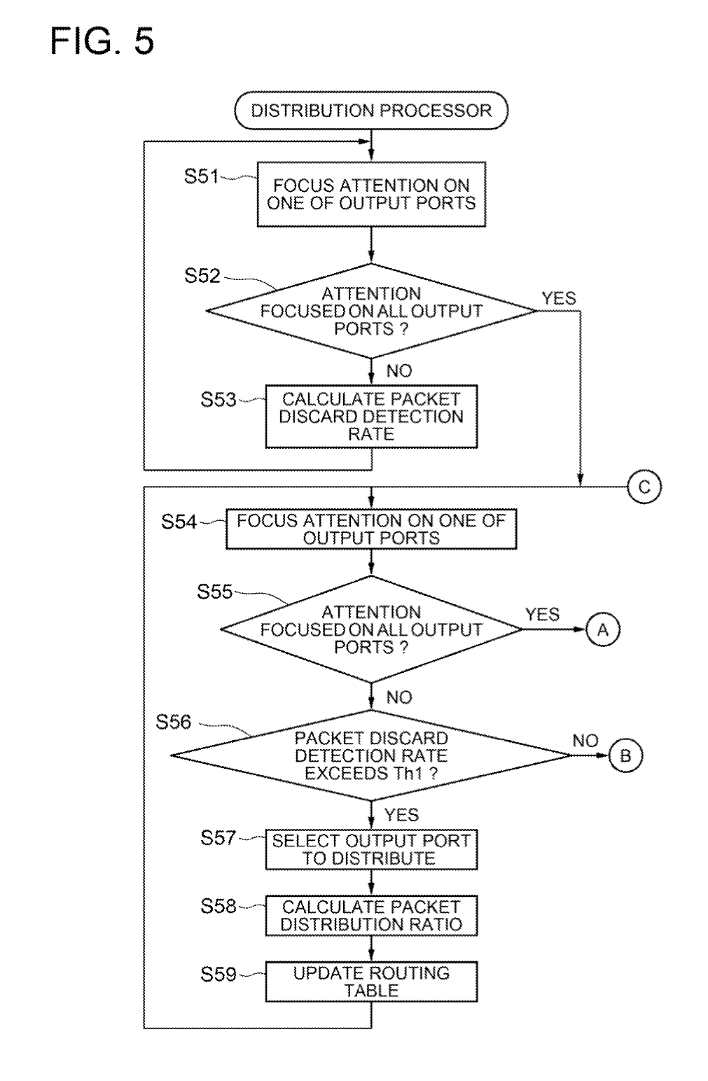

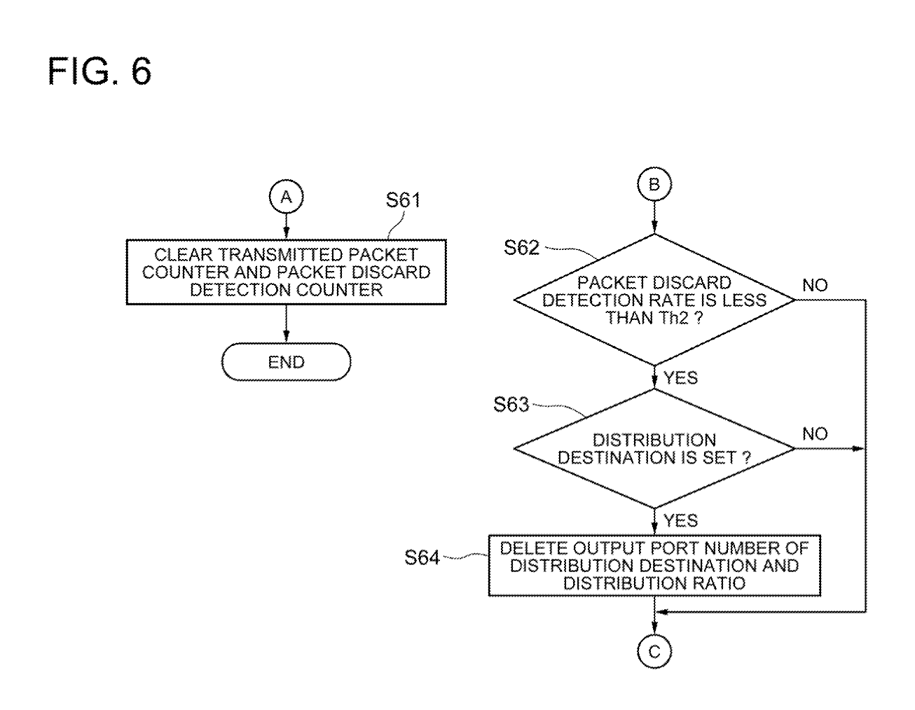

Referring to flowcharts of FIGS. 5 and 6, processing to be performed by the distribution processor 18 will be described. The distribution processor 18 performs the processing shown in the flowcharts of FIGS. 5 and 6 at regular time intervals.

Firstly, the distribution processor 18 focuses attention on one of the output ports 12-1 to 12-k, and calculates a packet discard detection rate Pa of the output port under the attention (e.g. the output port 12-a) (steps S51 and S53). More specifically, the distribution processor 18 receives inputs of a count value Ta from the transmitted packet counter 15-a corresponding to the output port 12-a and a count value Na from the discard detection counter 17-a, and performs the calculation (1) above, whereby the packet discard detection rate of the output port 12-a is obtained as Pa=Na/Ta: The distribution processor 18 then focuses attention on the next output port and performs the same processing as described above.

Once the similar processing as described above has been performed for all of the output ports 12-1 to 12-k (YES in step S52), the distribution processor 18 again focuses attention on one of the output ports 12-1 to 12-k, and determines whether the packet discard detection rate Pa of the output port (e.g., the output port 12-a) is over the predetermined first threshold Th1 (steps S54 and S56).

If the packet discard detection rate Pa is over the first threshold Th1 (YES in step S56), the distribution processor 18 then selects one of the other output ports (an output port other than the output port 12-a) as the output port 12-b to which the packet is distributed (step S57). According to this embodiment, an output port having the smallest packet discard detection rate among the output ports other than the output port 12-a is selected as the output port 12-b as the distribution destination.

The distribution processor 18 then calculates a distribution ratio when the packets the destination of which correspond to the output port 12-a are distributed between the output port 12-a and the output port 12-b as the distribution destination (step S58). More specifically, the distribution processor 18 performs the calculation of the equations (2) and (3) above to find weights of A=1-Pa and B=Pa for the output ports 12-a and 12-b, respectively, whereby A:B=(1-Pa):Pa is obtained as the distribution ratio of the packets.

The distribution processor 18 then updates the contents of the routing table 16 so that the packets to be originally output to the output port 12-a can be distributed to the output port 12-b (step S59). More specifically, the port number of the output port 12-b and the packet distribution ratio of (1-Pa): Pa are recorded in the relevant fields of the routing table 14 associated with the destination (IP address) indicating that the output destination in normal mode is the port output port 12-a. By recording the port number of the output port 12-b as the distribution destination and the distribution ratio of (1-Pa):Pa in the routing table 14 in this manner, some of the packets to be normally distributed to the output port 12-a are distributed to the output port 12-b. The proportion of the packets distributed to the output port 12-a can be reduced as the packet discard detection rate Pa of the output port 12-a becomes greater. Therefore, the risk of occurrence of congestion in the network where the router 1 is arranged can be significantly reduced.

The distribution processor 18 then focuses attention on a next output port (step S54), and performs the same processing as described above.

When it is determined in step S56 that the packet discard detection rate Pa of the output port 12-a is over the first threshold Th1, the distribution processor 18 performs the processing described above. However, if it is determined in step S56 that the packet discard detection rate Pa of the output port 12-a is not more than the threshold Th1 (NO step S56), the distribution processor 18 performs processing as described below.

When the distribution processor 18 determines in step S56 that the packet discard detection rate Pa of the output port 12-a is not more than the threshold Th1, the distribution processor 18 then determines whether or not the packet discard detection rate Pa is less than the second threshold Th2 as shown in the flowchart of FIG. 6 (step S62).

When the packet discard detection rate Pa of the output port 12-a is equal to or more than the second threshold Th2 (NO in step S62), the distribution processor 18 returns to step S54 of FIG. 5 and focuses attention on a next output port. On the contrary, when the packet discard detection rate Pa is less than the second threshold Th2 (YES in step S62), the distribution processor 18 refers to the routing table 14 to determine whether or not a port number of an output port as the distribution destination and a distribution ratio are recorded in association with the port number (in normal mode) of the output port 12-a (step S63).

If there is no such record in the routing table 14, the distribution processor 18 returns to step S54 of FIG. 5 and focuses attention on a next output port. On the contrary, if there are relevant records in the routing table 14, the port number of the output port 12-b and the distribution ratio are deleted from the routing table 14 (step S64). As a result, the packets are not distributed to the output port 12-b but distributed only to the original output port 12-a to be used in normal mode. The distribution processor 18 then returns to step S54 of FIG. 5 and focuses attention on a next output port.

The distribution processor 18 repeatedly performs the aforementioned processing until there is no output port left to focus attention (YES in step S55 in FIG. 5), and the distribution processor 18 clears the transmitted packet counters 15-1 to 15-k and the packet discard detection counters 17-1 to 17-k as shown in the flowchart of FIG. 6 (step S61) and terminates the processing.

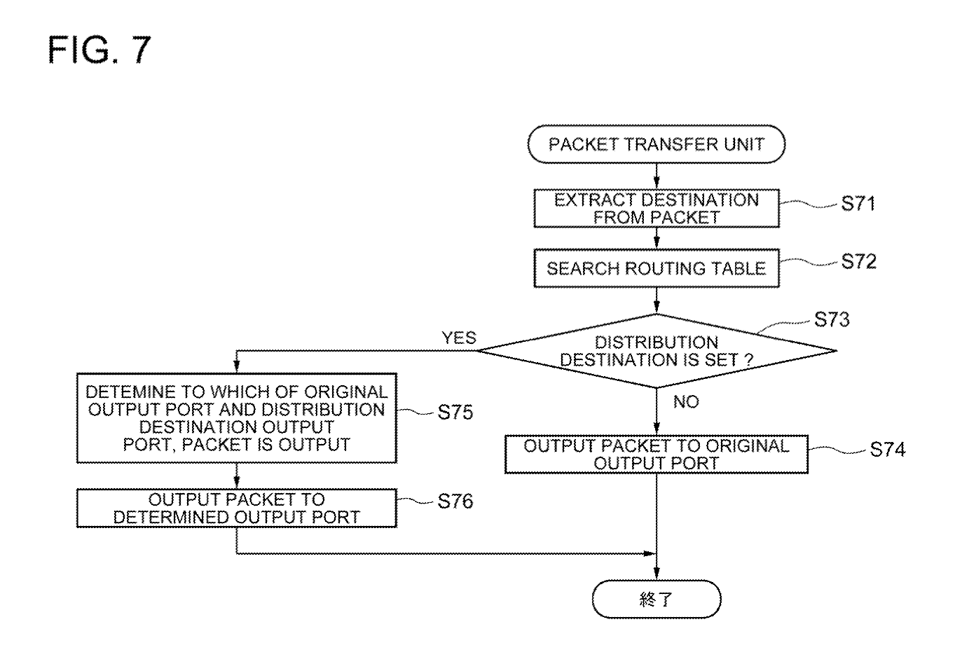

Referring to the flowchart of FIG. 7, operation of the packet transfer unit 13 will be described.

Upon receiving a packet through one of the input ports 11-1 to 11-j, the packet transfer unit 13 firstly extracts a destination (IP address) from the packet (step S71). The packet transfer unit 13 then searches the routing table 14 by using the destination extracted in step S71 as a key (step S72).

When the search result finds only the port number of the original output port that is used as an output destination in normal mode (NO in step S73), the packet transfer unit 13 outputs the packet to the original output port (step S74).

In contrast, when the search result contains, in addition to the port number of the original output port, the port number of the output port as the distribution destination and the distribution ratio (YES in step S73), the packet transfer unit 13 determines which of the original output port and the distribution destination output port is to be used as the output destination of the packet (step S75). Various methods may be used to determine the packet output destination. The method as described below for example may be used. A first counter and a second counter are prepared to count the number of packets output to the original output port and the number of packets output to the distribution destination output port during the period of time from the start of distribution to the current time. When determining an output destination of a packet, it is determined, based on the count values of the first and second counters, which of the output ports the packet should be output to in order to approximate the actual packet distribution ratio to the distribution ratio which is set in the routing table 14. The output port which is determined to be able to approximate the distribution ratio more is determined as the output destination for the packet. The packet transfer unit 13 then output the packet to either the output port for use in normal mode or the distribution destination output port, whichever is determined as the output destination in step S75, of (step S76).

For example, when the contents of the routing table 14 are as shown in FIG. 2 and the packet destination is “A1”, the packets are output only to the output port 12-1. However, when the packet destination is “A2”, the packets are output to the output port 12-2 for use in normal mode and the distribution destination output port 12-k in a distribution ratio of X:Y.

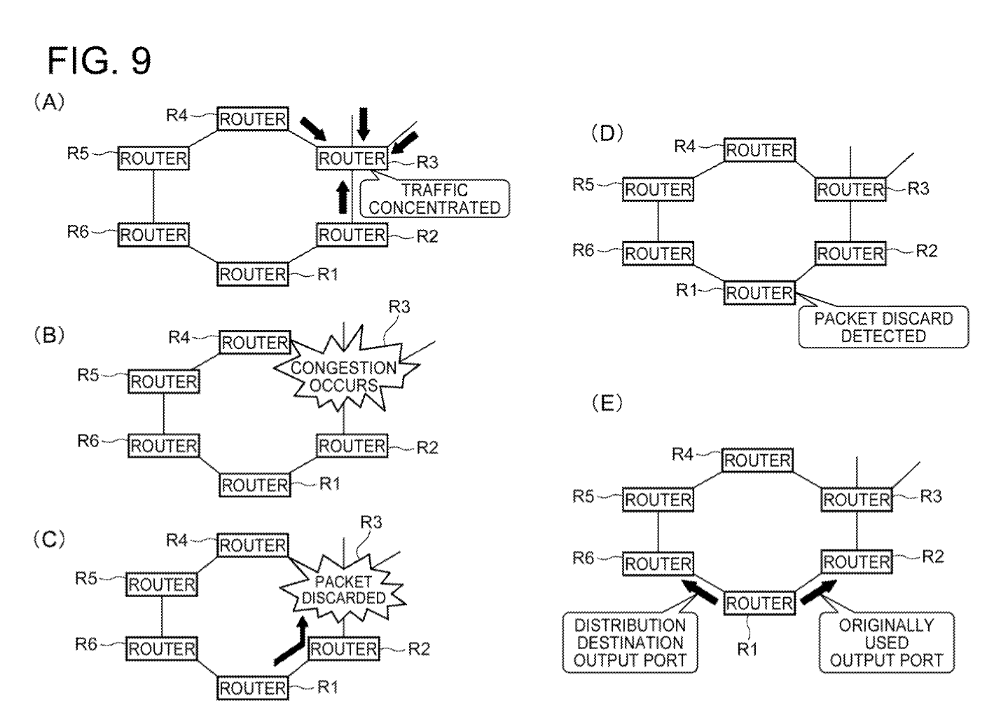

FIG. 9 is a diagram illustrating how traffic congestion is re-moved. Each of routers R1 to R6 shown in FIG. 9 has the configuration illustrated in FIG. 1.

If traffic is concentrated on the router R3 as shown in FIG. 9A, congestion occurs in the router R3 as shown in FIG. 9B. After that, the router R1 outputs a packet to the router R2 as shown in FIG. 9C. This packet is discarded by the router R3 where congestion has occurred. The packet discard detector 17 in the router R1 then detects that the packet has been discarded as shown in FIG. 9D. If the packet discard detection rate of the output port for transmitting packets to the router R2 is over the aforementioned first threshold Th1, the distribution processor 18 in the router R1 changes the contents of the routing table 14 and outputs the packets, while distributing them between the originally used output port and the distribution destination output port, as shown in FIG. 9E.

This first embodiment provides an advantage that the risk of occurrence of congestion can be reduced sufficiently. This is because the distribution processor 18 is provided which calculates a distribution ratio based on a packet discard detection rate of the output port 12-a having a packet discard detection rate (degree of congestion) exceeding the first threshold Th1, so that the calculated distribution ratio is used to distribute packets having a destination corresponding to the output port 12-a between the output port 12-a and the distribution destination output port 12-b.

Further, according to this embodiment, an output port having the lowest degree of congestion is used as the distribution destination output port so that the degree of congestion of the distribution destination output port is increased. This makes it possible to reduce the risk of occurrence of congestion.

### Second Embodiment

A router according to a second embodiment of this invention will be described. The second embodiment is characterized in that a distribution ratio for distributing packets between an original output port for use in normal mode and an output port for use as a distribution destination is determined on the basis not only of a packet discard detection rate of an output port at which the discard of a packet is detected, but also on a hop count from a router which has detected the discard of the packet to a router which has discarded the packet.

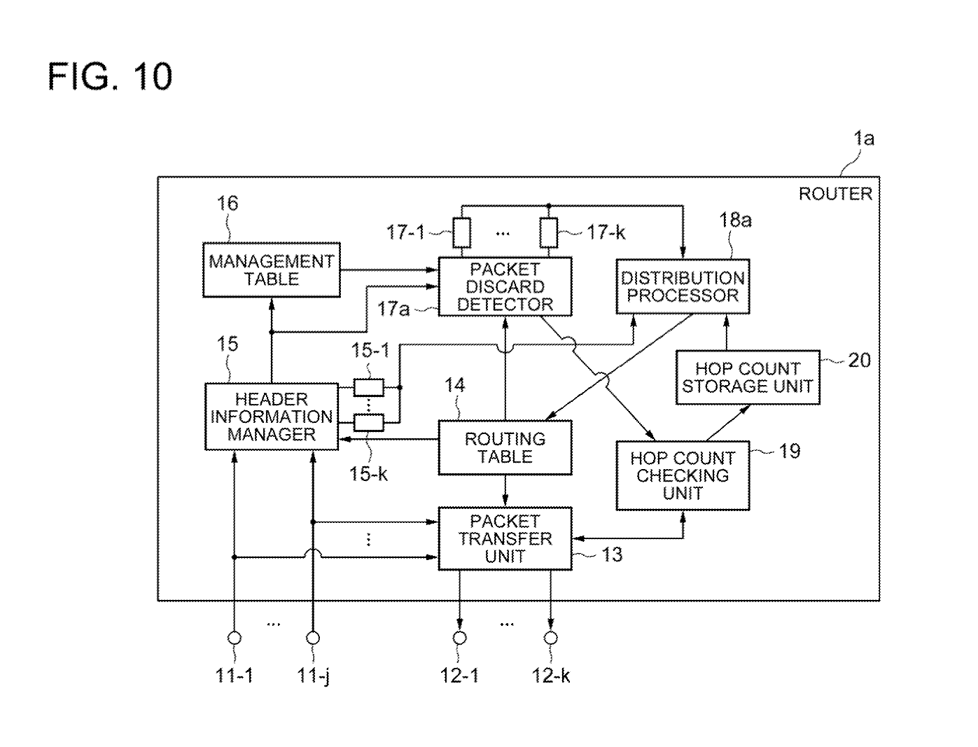

Referring to FIG. 10, a router 1a according to the second embodiment is different from the router 1 shown in FIG. 1 in that the router 1a has a packet discard detector 17a in place of the packet discard detector 17, and a distribution processor 18a in place of the distribution processor 18, and in that the router 1a is additionally provided with a hop count checking unit 19 and a hop-number storage unit 20.

The packet discard detector 17a has a function to instruct the hop count checking unit 19, when detecting that a packet output from the router 1a has been discarded, to check the hop count from the router 1a to the router which has discarded the packet. More specifically, when the packet discard detector 17a detects a discard of a packet in step S43 of FIG. 4, the packet discard detector 17a extracts a destination from a packet (retransmitted packet) passed from the header information manager 15, and passes a hop count checking instruction containing the extracted destination as the destination, to the hop count checking unit 19. Further, if the packet discard detector 17a detects a discard of a packet in step S45, the packet discard detector 17a extracts a transmission source from a packet (ACK packet) passed from the header information manager 15, and passes a hop count checking instruction containing the extracted transmission source as the destination, to the hop count checking unit 19.

Upon receiving the hop count checking instruction containing the destination passed from the packet discard detector 17a, the hop count checking unit 19 transmits hop count checking packets to the network via the packet transfer unit 13 in order to check the hop count from the router 1a to the router which has discarded the packet. These packets are transmitted by using the destination passed from the packet discard detector 17a as the destination and using the transmission source as the IP address of the local router 1a, while incrementing the TTL (Time to Live) by one for each packet (TTL value is incremented to 1, 2, 3 and onwards). Thus, the hop count checking unit 19 verifies whether or not an acknowledge packet is received in response to any of the transmitted packets. The hop count checking unit 19 recognizes a TTL value at which the receipt of the acknowledge packet is stopped as the hop count from the router 1a to the router which has discarded the packet, and records that hop count in association with the port number of the output port corresponding to the destination of the hop count checking packet, in the hop-number storage unit 20.

When the hop count checking unit 19 receives a hop count checking packet via the packet transfer unit 13 and if the TLL is “1”, the hop count checking unit 19 returns an acknowledge packet in response to this packet to the transmission source thereof via the packet transfer unit 13.

The packet transfer unit 13 outputs the hop count checking packet passed from the hop count checking unit 19, from an output port of the output ports 12-1 to 12-k corresponding to the destination of the hop count checking packet. When receiving an acknowledge packet in response to the hop count checking packet, the packet transfer unit 13 passes that acknowledge packet to the hop count checking unit 19.

The distribution processor 18a calculates, according the following equations (4) and (5), a weight A for an output port having a packet discard detection rate exceeding the first threshold Th1, and a weight B for an output port to be used as the distribution destination of the packet, so that the ratio of A:B defines a packet distribution ratio between these two output ports.

A=1−(Pa+1/M) (4)

B=Pa+1/M (5)

In the equations (4) and (5), M denotes a hop count from the local router 1a to a router which has discarded the packet, and Pa denotes a packet discard detection rate.

As the hop count from the local router to a router which has discarded the packet becomes smaller, the risk is increased that a packet output by the local router will be discarded. Therefore, according to the second embodiment, the distribution ratio between the output port having a packet discard detection rate exceeding the threshold Th1 and the output port used as the packet distribution destination is set as indicated by the equations (4) and (5) above, so that the number of packets distributed to the output port having the packet discard detection rate exceeding the threshold Th1 becomes smaller as the hop count from the local router to the router which has discarded the packet becomes smaller. Thus, the risk of occurrence of congestion can be reduced more than in the first embodiment.

Next, operation of this second embodiment will be described. The description here will be made focusing on differences from the first embodiment.

When determining that a packet has been discarded in step S43 of FIG. 4, the packet discard detector 17a extracts a destination from a packet (retransmitted packet) passed from the header information manager 15, and passes a hop count checking instruction containing the extracted destination as the destination to the hop count checking unit 19. These processing steps are performed in addition to the processing performed by the packet discard detector 17 of the first embodiment. When determining that a packet has been discarded in step S45, the packet discard detector 17a extracts a transmission source from a packet (ACK packet) passed from the header information manager 15, and passes a hop count checking instruction containing the extracted transmission source as the destination to the hop count checking unit 19. These processing steps are performed in addition to the processing performed by the packet discard detector 17 of the first embodiment,

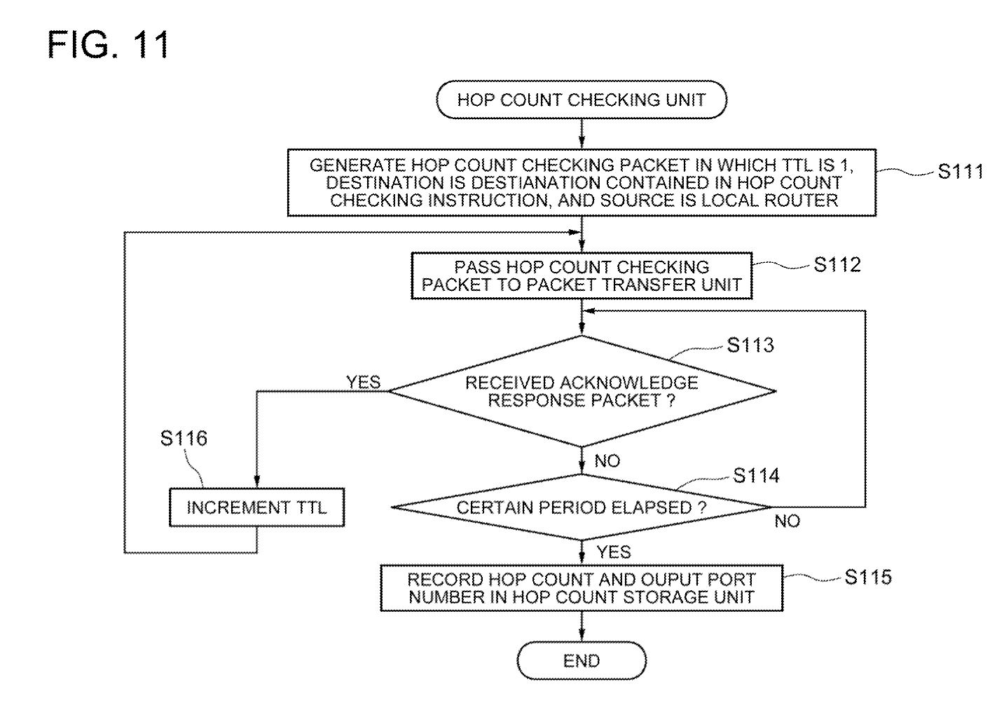

Upon receiving the hop count checking instruction containing the destination from the packet discard detector 17a, the hop count checking unit 19 generates a hop count checking packet in which TLL is set to “1”, the destination is set to the destination contained in the hop count checking instruction, and the transmission source is set to the IP address of the local router 1a, and passes the generated packet to the packet transfer unit 13 (steps S111 and S112 in FIG. 11). After that, the hop count checking unit 19 assumes a standby state waiting for reception of an acknowledge packet. On the other hand, upon receiving the hop count checking packet passed by the hop count checking unit 19, the packet transfer unit 13 refers to the routing table 14 and outputs the hop count checking packet from the corresponding output port.

The hop count checking packet output by the router 1a is received by an adjacent router.

The packet transfer unit 13 in the adjacent router passes the received hop count checking packet to the hop count checking unit 19, while referring to the routing table 14 to transmit the hop count checking packet to an adjacent node via a corresponding output port. The TTL is decremented b_{y} one before outputting the hop count checking packet. If the TTL becomes “0” as a result of the decrement by one, the hop count checking packet is discarded without outputting the same from an output port. Upon receiving the hop count checking packet passed by the packet transfer unit 13, the hop count checking unit 19 passes an acknowledge packet to the packet transfer unit 13 if the TTL is “1”, so that a response is given to the router 1a as the transmission source of the hop count checking packet. If the node which has received the hop count checking packet is a node which is congested and has discarded the packet from the router 1a, the possibility is high that the hop count checking packet will be discarded and no acknowledge packet will be returned to the router 1a.

Upon receiving the acknowledge packet in response to the hop count checking packet, the packet transfer unit 13 in the router 1a as the transmission source of the hop count checking packet passes the acknowledge packet to the hop count checking unit 19. When the hop count checking unit 19 receives an acknowledge packet within a predetermined period of time after transmitting a hop count checking packet while it is in the standby state waiting for reception of the acknowledge packet (YES in step S113 of FIG. 11), the hop count checking unit 19 generates a hop count checking packet in which the TTL has been incremented, and passes the generated packet to the packet transfer unit 13 (steps S116 and S112).

On the contrary, when the hop count checking unit 19 does not receive an acknowledge packet even after elapse of the predetermined period of time (YES in step S114), the hop count checking unit 19 recognizes the current TTL value as the hop count from the local router 1a to the router which has discarded the packet, and records this hop count and the hop count checking packet in the hop-number storage unit 20, in association with the port number of the output port (step S115).

Operation of the distribution processor 18a will be described. Difference from the distribution processor 18 according to the first embodiment shown in FIG. 1 resides only in the processing in step S58 of FIG. 5. Therefore, the description will be made only of this point.

According to the second embodiment, the distribution processor 18a performs calculation of the aforementioned equations (4) and (5) in step S58 to thereby obtain the weights A and B of the output port 12-a having a packet discard detection rate exceeding the threshold Th1 and the output port 12-b to be used as the packet distribution destination. The distribution ratio is defined by the ratio of A:B. The other steps of the operation are the same as those of the distribution processor 18a shown in FIG. 1.

According to this second embodiment, the risk of occurrence of congestion can be reduced more than in the first embodiment. This is because, in the second embodiment, the distribution processor 18a takes into consideration the hop count from the local router 1a to a router which has discarded a packet when calculating a distribution ratio for distributing packets between the output port 12-a having a packet discard detection rate exceeding the first threshold Th1 and the output port 12-b to be used as the distribution destination.

This invention is applicable to packet relay devices such as routers and L3 switches.

What is claimed is:

1. A packet relay device comprising:
a plurality of input ports each of which inputs a packet;
a plurality of output ports each of which outputs a packet;
a packet discard detector for detecting, for each of the output ports, a discard of a packet output from the output port;
a distribution processor for calculating a degree of congestion for each of the output ports based on a result of detection by the packet discard detector to find a first output port having a degree of congestion exceeding a threshold, selecting from the plurality of output ports a second output port to be used as a packet distribution destination for the first output port, and calculating a distribution ratio for distributing a packet having a destination corresponding to the first output port between the first output port and the second output port based on the degree of congestion of the first output port; and
a packet transfer unit for distributing the packet received through the input port and having a destination corresponding to the first output port, between the first output port and the second output port according to the distribution ratio calculated for the first output port.

2. The packet relay device according to claim 1, wherein the degree of congestion of the output port is a packet discard detection rate indicating a ratio between a total number of packets output from the output port during a predetermined period of time and a number of packets discarded after being output from the output port during the predetermined period of time.

3. The packet relay device according to claim 1, wherein the distribution processor selects an output port having the lowest degree of congestion among the plurality of output ports as the second output port.

4. The packet relay device according to claim I, wherein the distribution ratio is set such that as the degree of congestion of the first output port becomes greater, the number of packets distributed to the first output port is reduced.

5. The packet relay device according to claim 1, wherein the distribution processor calculates the distribution ratio on the basis of the degree of congestion of the first output port and a hop count from the packet relay device as a local device to a packet relay device which has discarded the packet.

6. The packet relay device according to claim 5, wherein the distribution ratio is set such that as the hop count from the local device to the packet relay device which has discarded the packet becomes smaller, the number of packets distributed to the first output port is reduced.

7. The packet relay device according to claim 1, wherein when the packet discard detector detects a packet retransmitted in the same connection, the packet discard detector determines that the packet output from the output port corresponding to the destination of the retransmitted packet has been discarded.

8. The packet relay device according to claim 1, wherein when the packet discard detector detects a plurality of ACK responses to the same packet in the same connection, the packet discard detector determines that the packet output from the output port corresponding to the transmission source of the ACK responses has been discarded.

9. The packet relay device according to claim 1, wherein when the distribution ratio is not calculated for the output port corresponding to the destination of a packet input through the input port, the packet transfer unit outputs the packet to the output port.

10. A packet relay method applicable to a packet relay device having a plurality of input ports each of which inputs a packet and a plurality of output ports each of which outputs a packet, the method comprising:
detecting, for each of the output ports, a discard of a packet output from the output port;
calculating a degree of congestion for each of the output ports based on a result of the detection;
selecting, from among the plurality of output ports, a second output port to be used as a packet distribution destination for a first output port having a calculated degree of congestion exceeding a threshold;
calculating a distribution ratio for distributing a packet having a destination corresponding to the first output port between the first output port and the second output port based on the degree of congestion of the first output port; and
distributing the packet input through the input port and having a destination corresponding to the first output port between the first output port and the second output port according to the distribution ratio calculated for the first output port.

11. A computer readable recording medium having a program recorded thereon for causing a computer having a plurality of input ports each of which inputs a packet and a plurality of output ports each of which outputs a packet to function as a packet relay device, the program being designed to cause the computer to realize:
a packet discard detector for detecting, for each of the output ports, a discard of a packet output from the output port;
a distribution processor for calculating a degree of congestion for each of the output ports based on a result of detection by the packet discard detector to find a first output port having a degree of congestion exceeding a threshold, selecting from the plurality of output ports a second output port to be used as a packet distribution destination for the first output port, and calculating a distribution ratio for distributing a packet having a destination corresponding to the first output port between the first output port and the second output port based on the degree of congestion of the first output port; and
a packet transfer unit for distributing the packet received through the input port and having a destination corresponding to the first output port between the first output port and the second output port according to the distribution ratio calculated for the first output port.
